(19) United States
(12) Patent Application Publication
(10) Pub. No.: US 2011/0320997 A1
(43) Pub. Date: Dec. 29, 2011

(54) Delay-Cell Footprint-Compatible Buffers

(75) Inventors: Farid Labib, Diessen (DE); Herbert Preuthen, Dorfen (DE); Juergen Dirks, Holzkirchen (DE); Stefan G. Block, Munich (DE)

(73) Assignee: LSI CORPORATION, Milpitas, CA (US)

(21) Appl. No.: 12/822,272

(22) Filed: Jun. 24, 2010

(51) Int. Cl. G06F 17/50

(52) U.S. Cl. 716/119

(57) ABSTRACT

A method for creating a design for an integrated circuit, by developing a set of delay cells where each of the cells in the set has a different delay time from the other cells in the set, and where each of the cells in the set has the same surface area, has the same pin-outs, has the same drive strength, and has the same input capacitance, where an originally-used cell in the set can be swapped out for a different replacement cell in the set without any impact on the design of the integrated circuit besides a change in delay time from the originally-used cell to the replacement cell.

### FIELD

This invention relates to the field of integrated circuits. More particularly, this invention relates to design cell libraries and flow for the design of integrated circuits.

### INTRODUCTION

In today's complex custom silicon solutions, with an ever-decreasing time to market window, predictable turnaround time become imperative for the success of a product. Delays in schedule immediately turn into profit-loss, and under certain circumstances even to the cancellation of the project. A typical scenario is a late design change just before signoff. This late change is, for example, necessary due to a timing violation found in the complex static timing analysis scenarios in the chip verification. This late timing change may need to revert a previously-inserted delay cell for hold time fixing into a normal buffer, because the delay cell was causing a setup violation at another signoff corner.

There are various reasons why such a scenario is highly probably to happen, such as:
1. Highly complex timing constraints, especially for test modes, causing long signoff static timing analysis runtimes;
2. Complex designs implemented with more hard macros, causing a flat signoff-static timing analysis to happen very late;
3. Shrinking technology nodes requiring more off-corner verification for signoff which cannot all be verified already in layout tools because complexity of signoff test timing constraints exceeds runtime and memory capacity limits of layout tools; and
4. Different understanding of timing between layout tools and signoff-static timing analysis tools.

These factors can cause a hold fix to turn into a setup violation in an off-corner delay case in signoff static timing analysis. This is typically caught very late on a signoff-ready database. To fix the issue requires swapping back from a delay cell to a buffer very late in the design process.

An existing solution to these problems includes swapping a large delay cell back to a smaller non-footprint-equivalent buffer. Metal wires have to be re-connected, and well-filling needs to be repaired. Afterwards, a full back-annotation, timing, and physical verification has to be performed.

The likelihood of introducing new violations during such a process is very high, because the drive strengths of the new buffer and the old delay cell are different. In addition, the new buffer might create a different cross-talk timing window, again leading to new violations. Fixing broken wires and base layer polygons also increases the risk of newly induced design rule violations, which again have to be fixed, and thus add to the overall turn-around time of the fix.

Additional turn-around time in the range of days (for fix, layout verification system, design rules check violations risk; standard parasitic extraction, static timing analysis) is very probable. The delay is often even longer, depending on the complexity of the verification tasks using the traditional libraries, which do not contain buffers that are footprint-equivalent to delay cells. An additional turn time of up to one week may be required to get from the implementation of the fix to the complete verification phase (from timing fix back to manufacturability).

Thus, the traditional way might take up to several days until the design process returns back to final verification, as described above, because existing cell libraries do not contain footprint-equivalent versions of exchangeable delay-cells and simple buffers.

Thus, the replacement of a delay cell with a simple buffer requires additional post processing steps that add to the turn-around time and reduce the predictability of results in the late design phase.

What is needed, therefore, is a system that overcomes problems such as these, at least in part.

### SUMMARY OF THE CLAIMS

The above and other needs are met by a method for creating a design for an integrated circuit, by developing a set of delay cells where each of the cells in the set has a different delay time from the other cells in the set, and where each of the cells in the set has the same surface area, has the same pin-outs, has the same drive strength, and has the same input capacitance, where an originally-used cell in the set can be swapped out for a different replacement cell in the set without any impact on the design of the integrated circuit besides a change in delay time from the originally-used cell to the replacement cell.

According to another aspect of the invention there is described a set of delay cells for use in a design for an integrated circuit, where each of the cells in the set has a different delay time from the other cells in the set, the same surface area as the other cells in the set, the same pin-outs as the other cells in the set, the same drive strength as the other cells in the set, and the same input capacitance as the other cells in the set, where an originally-used cell in the set can be swapped out of the design for a different replacement cell in the set without any impact on the design of the integrated circuit besides a change in delay time from the originally-used cell to the replacement cell.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a flow chart of a method for using a set of D-FEQ cells according to an embodiment of the present invention.

FIG. 2 is a representation of a set of D-FEQ cells according to an embodiment of the present invention.

### DETAILED DESCRIPTION

Various embodiments of the invention develop a new cell type that has not been developed before. This new cell type is a buffer called a design footprint-equivalent (D-FEQ) buffer, which can be used during the design phase of an integrated circuit. The D-FEQ cell can be used either as a buffer or as a delay cell. These D-FEQ cells are developed in sets. For example, in one set there might be two versions of a cell. These two cells have the same footprint and electrical characteristics, such as the same drive strength and capacitance. However, one cell has a delay of 100 picoseconds (for example), while the other cell has a delay of 50 picoseconds (for example). These two cells can be exchanged without any impact to the chip-level design layout.

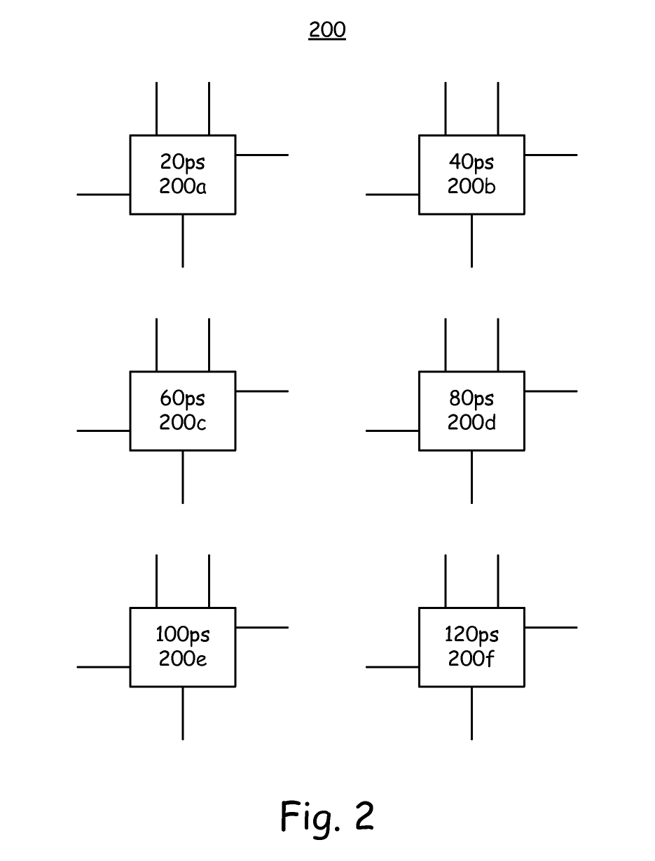

The only difference between the two cells as far as the design engineer is concerned, is in the 50 picosecond difference in the timing delay, and not in the physical layout. These D-FEQ cells can be swapped out, one for another, for cells that were used at an earlier point in time in the design phase, but then when the final signoff timing forces a smaller delay, a different D-FEQ buffer that is faster can be swapped in, which does not destroy the layout, because it has the exact same physical boundaries, pin-outs, and so forth, so that it physically matches the larger delay cell completely. FIG. 2 depicts such a set of D-FEQ cells 200, where the different cells 200 have all of the same characteristics, except for the delay, as indicated. It is appreciated that the representation of the different cells 200 is by way of simplified example only, and that in actual implementation the size, shape, pin-outs, delays, and other characteristics of the cells 200 will be different from those as indicated.

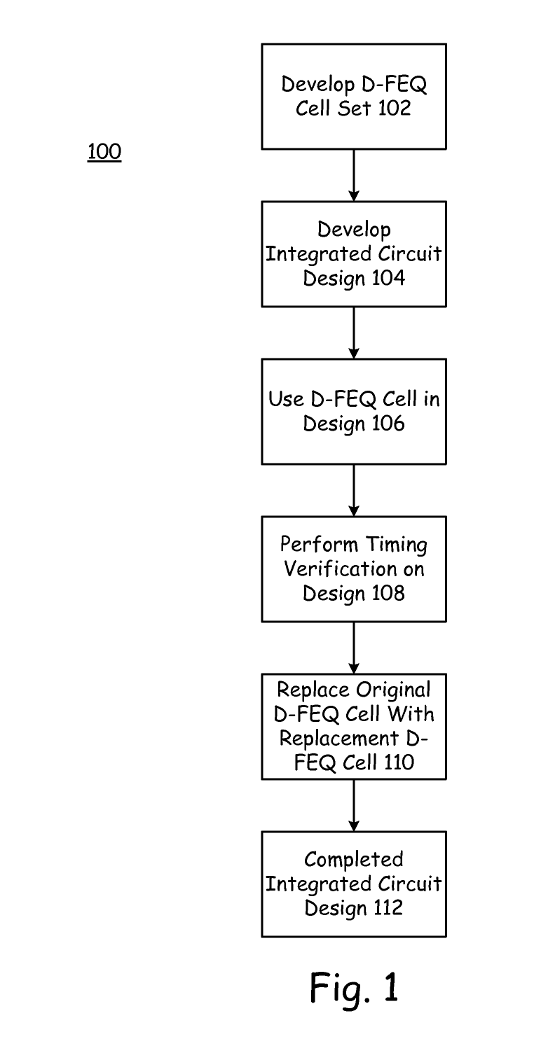

Thus, according to one embodiment of the present invention as depicted in the method 100 of FIG. 1, a set of buffers 200 (as depicted in FIG. 2) are developed, as given in block 102, that all have the same external characteristics (layout size, pin-outs, drive strength, etc.), but with different delays. A design for an integrated circuit is developed as given in block 104, which uses one or more of the buffers 200, as given in block 106. Later during the design process, a timing verification is performed for the design, as given in block 108. If the timing verification indicates that changes in the timing of the design need to be made, then as given in optional step 110, the original buffer 200 from the set is pulled out of the design, and the appropriate one of the other buffers 200 from the set, having the needed delay, is dropped into the design. The design is then completed as given in block 112, without having to perform additional adjustments to the design.

The max-capacitance/drive strength equivalence allows a very accurate prototyping during the exchange process with respect to the expected timing delay. One can estimate the timing in the static timing analysis tool with a very high accuracy as compared to the timing after real implementation. In this manner, the risk of not meeting the target and having to do another round of analysis is very low. This method saves up to several days when such changes have to be made near the end of the design process, such as close to tape-out, where the most accurate extraction and timing analysis is required.

The physical equivalence (pins and size, etc.) of the cells within the set does not require any repair of routing after an exchange of buffers with different delays. Therefore, this method does not require any re-extraction of parasitic values. The physical equivalence at the boundary of such cells, including matching n-well, filling, etc. (mask rules) reduces the risk that after a cell exchange as described above, a mask design rule violation will be created. To do this according to old methods runs the risk that another round of verification will be required.

Various embodiments of the present invention contribute to the predictability of a design schedule at the very end of the implementation phase, where every day, even every hour, counts. With the proposed embodiments, additional loops in the final phase can be reduced.

According to the various embodiments, new footprint-equivalent derivates of delay cells are developed, which can be swapped in for the originally-inserted delay cell (which were, for example, causing a setup violation during signoff verification).

The characteristics of those new footprint-equivalent buffers are:

1. They exhibit the same surface area as the original delay cell,
2. They have the same pin-outs as the original delay cell,
3. They have the same drive strength as the original delay cell, and
4. They have the same input capacitance as the original delay cell.

The only difference between the delay cell and the buffer is the delay they have. This delay is desired to vary between a normal buffer and a typical delay cell for hold fixing.

The new methods allows a quasi-zero-time budget for replacing the cells, with minimal overhead of re-verification, and with virtually zero risk of the need to do yet another round of checks.

For example, there are no wires to be fixed, no layout verification system or design rule check errors, no standard parasitic extraction, and only a new sign-off static-timing analysis run. Further, the timing is virtually completely predictable upfront in static timing analysis, and the turn-around time is less then a working day.

In addition, the design of the D-FEQ buffers comes with very low effort and cost, because one only needs to fit a small standard cell into a bigger body. It is easy to apply footprint-equivalent pin-coordinates and enlarge base-layer polygons like n-wells to fit to the outline of the existing delay cells.

Another embodiment of the method is to enlarge the set of footprint-equivalent cells to include not only buffers/delay cells, but also a wider set of standard cells.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. In a method for creating a design for an integrated circuit, the improvement comprising the step of:
developing a set of delay cells, where each of the cells in the set has a different delay time from the other cells in the set, and where each of the cells in the set,
has the same surface area,
has the same pin-outs,
has the same drive strength, and
has the same input capacitance,
where an originally-used cell in the set can be swapped out for a different replacement cell in the set without any impact on the design of the integrated circuit besides a change in delay time from the originally-used cell to the replacement cell.

2. A set of delay cells for use in a design for an integrated circuit, where each of the cells in the set has:
a different delay time from the other cells in the set,
the same surface area as the other cells in the set,
the same pin-outs as the other cells in the set,
the same drive strength as the other cells in the set, and
the same input capacitance as the other cells in the set,
where an originally-used cell in the set can be swapped out of the design for a different replacement cell in the set without any impact on the design of the integrated circuit besides a change in delay time from the originally-used cell to the replacement cell.
